(19) United States
(12) Patent Application Publication
(10) Pub. No.: US 2022/0087002 A1
(43) Pub. Date: Mar. 17, 2022

(54) DIELECTRIC BARRIER DISCHARGE DEVICE

(71) Applicant: KABUSHIKI KAISHA TOSHIBA, Tokyo (JP)

(72) Inventors: Yosuke SATO Sato, Kawasaki Kanagawa (JP); Akio Ui, Suginaki Tokyo (JP); Masato Akita, Shinjuku Tokyo (JP); Shotaro Oka, Tokyo (JP)

(73) Assignee: KABUSHIKI KAISHA TOSHIBA, Tokyo (JP)

(21) Appl. No.: 17/192,757

(22) Filed: Mar. 4, 2021

(30) Foreign Application Priority Data
Sep. 16, 2020 (JP) 2020-155735

(51) Int. Cl. H05H 1/24

(52) U.S. Cl. CPC H05H 1/2406; H05H 2001/2456; H05H 2001/2412

(57) ABSTRACT

A dielectric barrier discharge device in an embodiment includes: a dielectric having a hollow-shaped flow path; a first electrode and a second electrode provided apart along the dielectric so as to cause a first region in which plasma is formed inside the flow path; and a power supply to apply a voltage between the first electrode and the second electrode. The dielectric includes a flow path area adjusting portion provided to project from an inner wall of the dielectric toward a center of the flow path in a manner that a first flow path cross-sectional area in the first region is smaller than a second flow path cross-sectional area in a second region other than the first region in the flow path.

### CROSS REFERENCE TO RELATED APPLICATION

This application is based upon and claims the benefit of priority from Japanese Patent Application No. 2020-155735, filed on Sep. 16, 2020; the entire contents of which are incorporated herein by reference.

### FIELD

The embodiment disclosed herein relates to a dielectric barrier discharge device.

### BACKGROUND

As a typical method for generating low-temperature plasma under an atmospheric pressure, a dielectric barrier discharge (DBD) method is known. A discharge device (hereinafter, also referred to as a DBD device) to which the DBD is applied is normally constituted by a pair of electrodes and a dielectric, and application of a high voltage of several kV to several ten kV, for example, to the pair of electrodes makes discharge (dielectric breakdown) of a gas occur, to generate plasma. Setting a voltage waveform to be an alternating waveform or a pulse waveform enables concentrative acceleration (heating) of only the electrons, so that a temperature of the gas can be suppressed at a level of a room temperature (about 300 K) while an electron temperature becomes as high as about 10000 to 200000 K (about 1 eV to 20 eV, about 11000 K=1 eV). Such a state is referred to as non-equilibrium plasma or low-temperature plasma.

As the DBD device, for example, there has been known a structure in which the shape of a dielectric is a tube shape such as a cylinder through which a process gas or the like is circulated and a set of electrodes is arranged around the dielectric. According to the DBD device with this structure, a high voltage is applied to the electrodes arranged around the dielectric to generate plasma inside the tube-shaped dielectric, thereby making it possible to enhance the processability of the process gas or the like circulating inside the dielectric. However, unless the plasma can be generated uniformly inside the tube-shaped dielectric, part of the process gas or the like that does not pass through the plasma will pass through in an unprocessed state. In most of the conventional DBD devices, there has been studied to improve the uniformity of the plasma produced inside the tube-shaped dielectric by improving the electrode arrangement and shape, dielectric material, voltage waveform, and the like. However, the conventional DBD device has not always obtained a sufficient effect, resulting in that there has been a need to improve the uniformity of the plasma produced inside the tube-shaped dielectric more easily and reproducibly.

### BRIEF DESCRIPTION OF THE DRAWINGS

FIG. 1 is a perspective view illustrating a dielectric barrier discharge device in an embodiment.

FIG. 2 is a cross-sectional view of the dielectric barrier discharge device illustrated in FIG. 1.

FIG. 3 is a cross section illustrating one example of a flow path shape of a dielectric in the dielectric barrier discharge device illustrated in FIG. 1.

FIG. 4 is a cross section illustrating another example of the flow path shape of the dielectric in the dielectric barrier discharge device illustrated in FIG. 1.

FIG. 5 is a cross-sectional view illustrating a first modified example of a dielectric barrier discharge electrode in the embodiment.

FIG. 6 is a cross-sectional view illustrating a second modified example of the dielectric barrier discharge electrode in the embodiment.

FIG. 7 is a cross-sectional view illustrating a third modified example of the dielectric barrier discharge electrode in the embodiment.

FIG. 8 is a view illustrating a simulation result of a plasma distribution by the dielectric barrier discharge device in the embodiment.

FIG. 9 is a view illustrating a simulation result of a plasma distribution by a dielectric barrier discharge device in a first comparative example.

FIG. 10 is a view illustrating a simulation result of a plasma distribution by a dielectric barrier discharge device in a second comparative example.

FIG. 11 is a cross-sectional view illustrating a first example of a flow path area adjusting portion in the dielectric barrier discharge device illustrated in FIG. 1.

FIG. 12 is a cross-sectional view illustrating a second example of the flow path area adjusting portion in the dielectric barrier discharge device illustrated in FIG. 1.

FIG. 13 is a cross-sectional view illustrating a third example of the flow path area adjusting portion in the dielectric barrier discharge device illustrated in FIG. 1.

FIG. 14 is a cross-sectional view illustrating a first modified example of the dielectric barrier discharge device illustrated in FIG. 1.

FIG. 15 is a cross-sectional view illustrating a second modified example of the dielectric barrier discharge device illustrated in FIG. 1.

### DETAILED DESCRIPTION

A dielectric barrier discharge device in an embodiment includes: a dielectric having a hollow-shaped flow path; a first electrode and a second electrode provided apart along the dielectric so as to cause a first region in which plasma is formed inside the flow path; and a power supply to apply a voltage between the first electrode and the second electrode, in which the dielectric includes a flow path area adjusting portion provided to project from an inner wall of the dielectric toward a center of the flow path in a manner that a first flow path cross-sectional area in the first region is smaller than a second flow path cross-sectional area in a second region other than the first region.

Hereinafter, a dielectric barrier discharge device in an embodiment will be explained with reference to the drawings. In each embodiment, substantially the same constituent parts are denoted by the same reference numerals and symbols and their explanations will be partly omitted in some cases. The drawings are schematic, and a relation of thickness and planar dimension among parts, a thickness ratio among parts, and so on are sometimes different from actual ones. Ten is indicating up and down directions in the explanation are sometimes different from actual directions based on a gravitational acceleration direction.

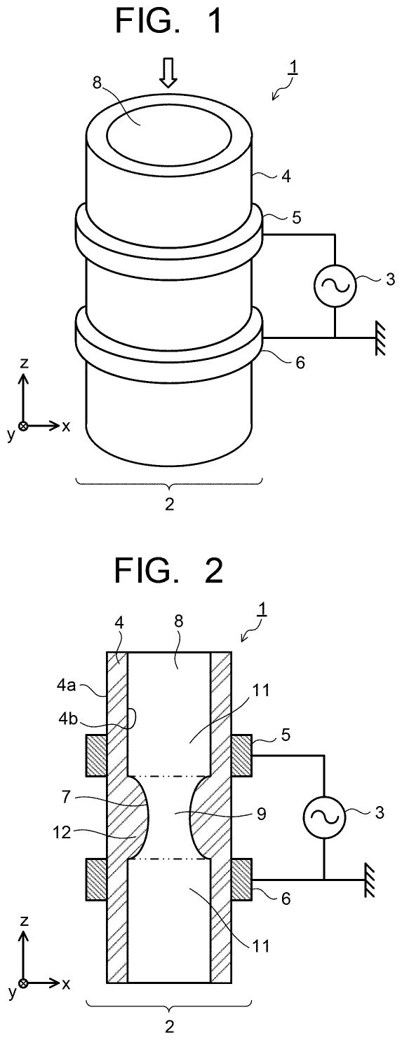

FIG. 1 is a perspective view illustrating a dielectric barrier discharge device in an embodiment, and FIG. 2 is a cross-sectional view illustrating the dielectric barrier discharge device in the embodiment. A dielectric barrier discharge device 1 illustrated in FIG. 1 and FIG. 2 includes a dielectric barrier discharge electrode 2 and a power supply 3 that applies a voltage to the dielectric barrier discharge electrode 2. The dielectric barrier discharge electrode 2 includes a dielectric 4, a first electrode 5, a second electrode 6, and a flow path area adjusting portion 7. The power supply 3 is electrically connected to the first electrode 5 and the second electrode 6. Applying a voltage from the power supply 3 to the first and second electrodes 5, 6 generates a discharge (dielectric breakdown) to produce plasma. Two directions parallel to and intersecting each other in a flow path cross section of the dielectric 4 are set to an x direction and a y direction, and a direction intersecting the x direction and the y direction (a flow path direction) is set to a z direction.

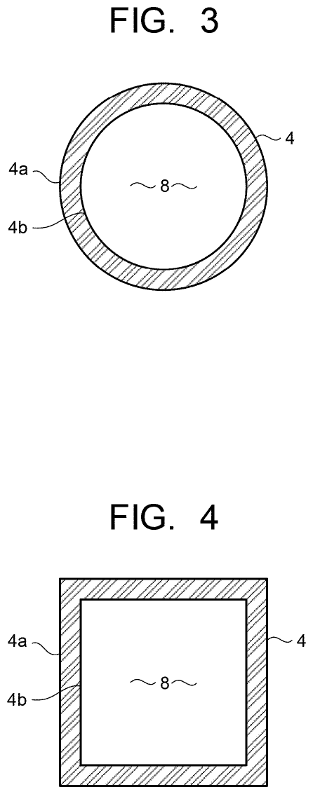

In the dielectric barrier discharge electrode 2, the dielectric 4 has a hollow-shaped flow path 8. The shape of the hollow-shaped dielectric 4 is not limited in particular, but a cylindrical shape is common, for example, as illustrated in a cross section of the flow path 8 in FIG. 3. The shape of the dielectric 4 may be a rectangular cylindrical shape such as a square in outline, as illustrated in a cross section of the flow path 8 in FIG. 4. The cross-sectional shape of the flow path 8 of the dielectric 4 may be circular illustrated in FIG. 3, square illustrated in FIG. 4, even oval, polygonal, or the like. However, the cross-sectional shape of the flow path 8 is preferably as symmetrical as possible in order to maintain the uniformity of discharge by the dielectric barrier discharge electrode 2. Further, in order to prevent an unintended discharge, the cross-sectional shape of the flow path 8 should not have too many corners. Therefore, the cross-sectional shape of the flow path 8 is preferably circular.

The inner dimension of the flow path 8 of the dielectric 4, for example, the inside diameter (diameter) of the flow path 8 having a circular cross-sectional shape is preferably 0.5 mm or more and 20 mm or less, and typically about 5 mm or more and 10 mm or less. When the inside diameter of the flow path 8 is too large, the distribution of the plasma formed is likely to be nonuniform and the voltage required to generate the discharge becomes high. When the inside diameter of the flow path 8 is too small, there is caused a problem that a gas will have difficulty in flowing. In the hollow-shaped flow path 8 of the dielectric 4, a gas to be processed, a reactive gas, or the like according to plasma processing is circulated in the z direction. For the dielectric 4, there are used, for example, glass materials such as alkali-free glass and borosilicate glass, ceramic materials such as alumina ceramics and silicon nitride ceramics, resin materials such as epoxy resin, polyether resin, and polyimide resin, and so on.

The first electrode 5 and the second electrode 6 are arranged along an outer wall 4a of the dielectric 4 as illustrated in FIG. 1 and FIG. 2, for example. The first electrode 5 and the second electrode 6 are arranged apart along the outer wall 4a of the dielectric 4 so as to cause a first region 9 in which plasma is formed inside the flow path 8. Applying a voltage from the power supply 3 to such first and second electrodes 5, 6 generates a dischame (dielectric breakdown) in the first region 9 of the flow path 8, to produce plasma. For the first electrode 5 and the second electrode 6, there are used, for example, metal materials such as copper, silver, chromium, titanium, and platinum. For example, a metal tape such as a copper tape is attached around the dielectric 4, and thereby the electrodes 5, 6 can be made. Further, a metal wire is wound around the dielectric 4 for several to several dozen times, and thereby the electrodes 5, 6 can also be made. The size of the electrodes 5, 6 is about several millimeters to several tens of millimeters in the axial direction (z direction) of the dielectric 4, and for example, the size of about 10 mm to 20 mm is suitably used.

A gap (distance) between the first electrode 5 and the second electrode 6 is preferably about 5 mm to several tens of millimeters. As the gap is larger to some extent, a plasma region (the first region 9) can be made wider. The gap is also related to the ease of discharge, and if the gap is too large, a higher voltage is required in order to generate the discharge, or the uniformity decreases in some cases. The gap is typically about 10 mm or more and 20 mm or less. An alternating-current waveform or a pulse waveform is used as the waveform of the voltage to be applied to the first and second electrodes 5, 6. As for the frequency of the alternating current, frequencies from several Hz to several GHz can be used. The typical frequency of the alternating current is from several kHz to several MHz, and microwaves in the order of GHz can also be used. A commercial power supply frequency (50 or 60 Hz) can also be used. A pulse waveform with a rise time of several nanoseconds to several hundred microseconds can be used as the pulse waveform.

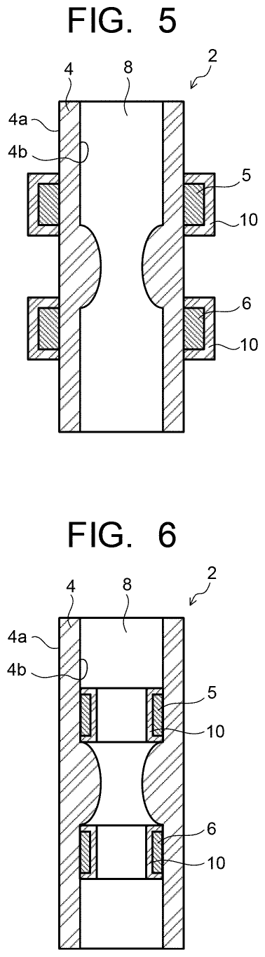

The first electrode 5 and the second electrode 6 are preferably covered with a dielectric material 10 as illustrated in FIG. 5. This makes it possible to prevent discharge between the first electrode 5 and the second electrode 6 that are exposed around the dielectric 4. The dielectric material 10 can be installed, for example, by covering the first and second electrodes 5, 6 with an insulating material. Examples of the above method include winding an insulating tape, installing an insulating liquid around the dielectric 4, solidifying the first and second electrodes 5, 6 with an insulating resin, and so on. Further, as illustrated in FIG. 6, the first electrode 5 and the second electrode 6 may be arranged along an inner wall 4b of the dielectric 4. In this case, the first electrode 5 and the second electrode 6 are covered with the dielectric material 10. The method of installing the dielectric material 10 is the same as that in the above-described case of installing the first and second electrodes 5, 6 along the outer wall 4a of the dielectric 4. Further, the first and second electrodes 5, 6 illustrated in FIG. 1 or FIG. 5 may be combined with the first and second electrodes 5, 6 illustrated in FIG. 6. That is, one of the first and second electrodes 5, 6 may be arranged along the outer wall 4a of the dielectric 4, and the other of them may be arranged along the inner wall 4b of the dielectric 4.

Inside the flow path 8 of the dielectric 4, a gas to be processed, a reactive gas, or the like is circulated according to plasma processing. For example, in the case where toxic components, odor components, or the like contained in a gas are processed, the gas to be processed containing such components is circulated inside the flow path 8. For example, in the case where a CH₄ gas is made to react with an O₂ gas to produce a fuel gas such as CH₃OH, a reactive gas containing such a reaction component is circulated inside the flow path 8. The process in the flow path 8 is not limited in particular, and various processes using plasma are applied, and the gas corresponding to the process is circulated inside the flow path 8. A flow rate of the gas to flow inside the flow path 8 of the dielectric 4 is expected to be several slm (standard litter per minute), and is typically 1 slm or more and 5 slm or less. This flow rate can be set by considering the time required for the gas to react, the residence time, or the like. There is a large difference in the time scale between a plasma production time (several nanoseconds to several tens of microseconds) and a gas flow time (several milliseconds), and thus, these can basically be considered independently.

The process of the gas generated inside the flow path 8 of the dielectric 4 is performed by the gas passing through the plasma generated in the first region 9. In this case, if the plasma generated in the first region 9 between the first electrode 5 and the second electrode 6 is nonuniform, there is caused a risk that part of the gas does not pass through the plasma, resulting in that part of the gas passes through in an untreated state. This results in a factor of a decrease in the processing efficiency of the dielectric barrier discharge device 1. Thus, in the dielectric barrier discharge electrode 2 in the embodiment, the flow path area adjusting portion 7 is provided in the flow path 8 of the dielectric 4. The flow path area adjusting portion 7 is provided to project from the inner wall 4b of the dielectric 4 toward the center of the flow path 8 so as to make a first flow path cross-sectional area in the first region 9 smaller than a second flow path cross-sectional area in a second region 11 that is other than the first region 9. The second region 11 other than the first region 9 is flow path regions corresponding to installation positions of the first electrode 5 and the second electrode 6, and is flow path regions corresponding to an upstream side of the first electrode 5 and a downstream side of the second electrode 6.

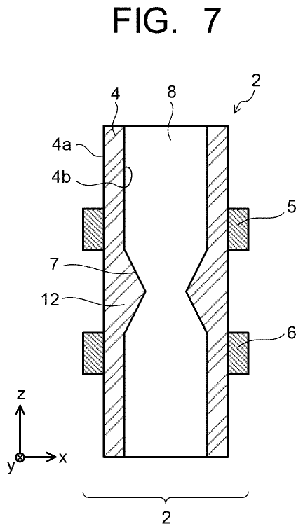

The flow path area adjusting portion 7 includes a convex portion 12 projecting from the inner wall 4b of the dielectric 4 toward the center of the flow path 8. The convex portion 12 narrows the inside diameter of the flow path 8, thereby reducing the first flow path cross-sectional area of the first region 9. The convex portion 12 of the flow path area adjusting portion 7 is not limited to the curved projection (a hemispherical shape in cross section, semielliptical shape in cross section, or the like) as illustrated in FIG. 2, but may be a straight projection (a triangular shape in cross section or the like) as illustrated in FIG. 7, for example. The shape of the convex portion 12 is not limited in particular, but only needs to the shape capable of making the first flow path cross-sectional area of the first region 9 smaller than the second flow path cross-sectional area of the second region 11. As above, by making the first flow path cross-sectional area of the first region 9 smaller than the second flow path cross-sectional areas of the second regions 11 on the upstream side and the downstream side thereof, plasma can be generated uniformly in the first region 9.

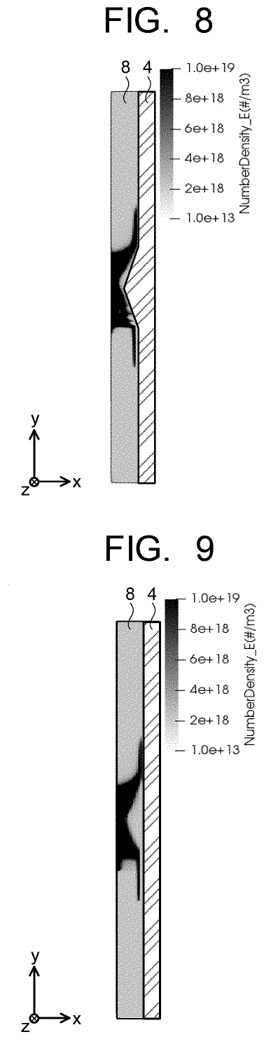

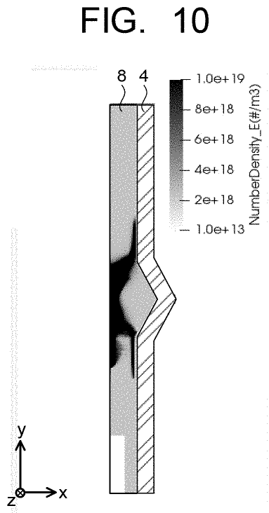

There is illustrated, in FIG. 8, a plasma distribution of the dielectric barrier discharge electrode 2 in the embodiment, which is obtained by a numerical simulation. FIG. 8 illustrates a distribution of an electron density in the plasma by a gray scale. The darker region of the gray scale indicates a region with a high plasma electron density, while the lighter region indicates a region where no plasma has been produced. For comparison, there is illustrated, in FIG. 9, a plasma distribution of a dielectric barrier discharge electrode using a dielectric 4 having a flow path 8 with no flow path area adjusting portion 7 provided therein (Comparative example 1), which is obtained by a numerical simulation. Further, there is illustrated, in FIG. 10, a plasma distribution of a dielectric barrier discharge electrode using a dielectric 4 having a flow path 8 that has a wider cross-sectional area in a plasma formation region than in other regions (Comparative example 2), which is obtained by a numerical simulation. FIG. 8, FIG. 9, and FIG. 10 each illustrate the numerical simulation result on one side of the dielectric 4 having the flow path 8 cut in half at the center line.

As illustrated in FIG. 9, it can be seen that in the flow path 8 with no flow path area adjusting portion 7 provided therein, namely, in the straight-tube-type flow path 8, there is a relatively wide light color region between the plasma and the dielectric 4 and there are generated many regions where no plasma is produced. In contrast to this, as illustrated in FIG. 8, it can be seen that in the flow path 8 with the first flow path cross-sectional area of the first region 9 made smaller than the second flow path cross-sectional areas of the second regions 11 on the upstream side and the downstream side thereof, the light color region between the plasma and the dielectric 4 is made smaller. This makes it easier for the gas flowing from upstream to pass through the plasma and accelerate the reaction. As illustrated in FIG. 10, it can be seen that when the flow path cross-sectional area is increased, the light color region is even wider. Therefore, from the viewpoint of the plasma distribution, even when the flow path cross-sectional area is increased, it is impossible to improve the uniformity of the plasma distribution.

In order to improve the uniformity of the above-described plasma distribution, the ratio of reducing the first flow path cross-sectional area of the first region 9 is preferably set to 30% or more and 90% or less of the second flow path cross-sectional area of the second region 11, and is more preferably set to 60% or more and 90% or less.

When the first flow path cross-sectional area exceeds 90% of the second flow path cross-sectional area, the effect of uniformizing the plasma density due to the above-described reduction in the flow path cross-sectional area may not be sufficiently obtained. In the meantime, when the first flow path cross-sectional area is less than 30% of the second flow path cross-sectional area, the flow velocity in that region may increase, leading to a decrease in the residence time for the reaction. Thus, the first flow path cross-sectional area is preferably 30% or more and 90% or less of the second flow path cross-sectional area, and more preferably set to 60% or more and 90% or less.

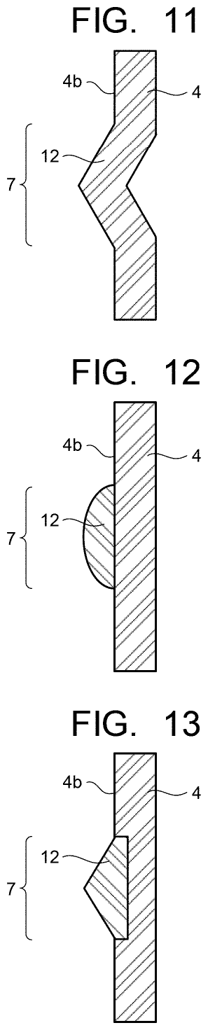

The dielectric 4 provided with the flow path 8 having the flow path area adjusting portion 7 can be fabricated as follow, for example. For example, as illustrated in FIG. 11, a part of the tube-shaped dielectric 4 is inwardly deformed by heat or force, thereby making it possible to obtain the flow path area adjusting portion 7 including the convex portion 12 projecting toward the center of the flow path 8. As illustrated in FIG. 12 and FIG. 13, a dielectric material is made to adhere to the inner wall 4b of the tube-shaped dielectric 4 toward the center, thereby making it possible to obtain the flow path area adjusting portion 7 including the convex portion 12, which is made of the dielectric material. FIG. 12 illustrates a state where the dielectric material is put on the inner wall 4b of the dielectric 4, to thereby form the convex portion 12. FIG. 13 illustrates a state where a part made of the dielectric material adheres to the inner wall 4b of the flow path 8. As illustrated in FIG. 12 and FIG. 13, in the case where the convex portion 12 is made of a dielectric material different from that of the dielectric 4, the dielectric material of the convex portion 12 may be a material different from that of the dielectric 4. FIG. 11, FIG. 12, and FIG. 13 each are a cross-sectional view of a state where the dielectric 4 is cut in half at the center line along the flow path 8.

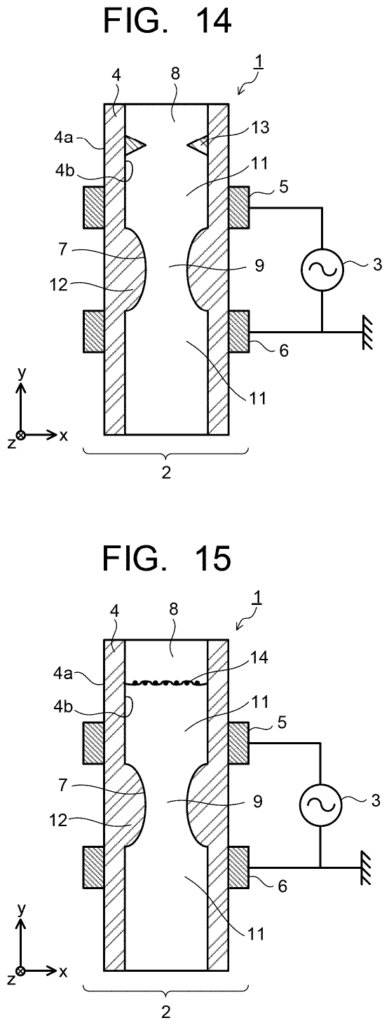

As illustrated in FIG. 8, even in the case of using the dielectric 4 having the flow path 8 provided with the flow path area adjusting portion 7, a light color region is slightly confirmed between the plasma and the inner wall 4b of the dielectric 4, resulting in that only devising the shape of the dielectric 4 is not enough and a region where no plasma is generated sometimes remains. Although it was confirmed that devising the shape of the dielectric 4 reduces the region where no plasma is generated, as a further innovation, a turbulence-generating member formed to disturb the flow of the gas to be circulated inside the flow path 8 is installed in the plasma region (first region 9) or the upstream region of the plasma region (first region 9) inside the flow path 8 to disturb the flow, thereby making it possible to promote mixing of the gas and the plasma. As a method of achieving such disturbance of the flow, as illustrated in FIG. 14, for example, providing a projection 13 on the inner wall of the dielectric 4 as the turbulence-generating member, as illustrated in FIG. 15, arranging a mesh-like material 14 inside the flow path 8 of the dielectric 4 as the turbulence-generating member, and so on are considered. Since these turbulence-generating members increase fluid resistance and work in the direction in which the gas is less likely to flow, they are preferably installed in consideration of the balance with the flow.

While certain embodiments of the present invention have been described, these embodiments have been presented by way of example only, and are not intended to limit the scope of the inventions. Indeed, the novel embodiments described herein may be embodied in a variety of other forms; furthermore, various omissions, substitutions and changes may be made without departing from the spirit of the inventions. The inventions described in the accompanying claims and their equivalents are intended to cover such forms or modifications as would fall within the scope and spirit of the inventions.

What is claimed is:

1. A dielectric barrier discharge device, comprising:
a dielectric having a hollow-shaped flow path;
a first electrode and a second electrode provided apart along the dielectric so as to cause a first region in which plasma is formed inside the flow path; and
a power supply to apply a voltage between the first electrode and the second electrode, wherein
the dielectric includes a flow path area adjusting portion provided to project from an inner wall of the dielectric toward a center of the flow path in a manner that a first flow path cross-sectional area in the first region is smaller than a second flow path cross-sectional area in a second region other than the first region in the flow path.

2. The device according to claim 1, wherein
the first flow path cross-sectional area of the flow path is in a range of 30% or more and 90% or less of the second flow path cross-sectional area.

3. The device according to claim 1, wherein
the first flow path cross-sectional area of the flow path is in a range of 60% or more and 90% or less of the second flow path cross-sectional area.

4. The device according to claim 1, wherein
the dielectric has the flow path whose cross section is approximately circular.

5. The device according to claim 1, wherein
the flow path area adjusting portion includes a projecting portion made by the inner wall of the dielectric being deformed toward the center.

6. The device according to claim 1, wherein
the flow path area adjusting portion includes a projecting portion containing a dielectric material adhering to the inner wall of the dielectric toward the center.

7. The device according to claim 6, wherein
the dielectric contains a first dielectric material, and
the projecting portion contains a second dielectric material different from the first dielectric material.

8. The device according to claim 1, wherein
the flow path area adjusting portion includes a projecting portion having an approximately hemispherical shape in cross section or an approximately semielliptical shape in cross section.

9. The device according to claim 1, wherein
the flow path area adjusting portion includes a projecting portion having an approximately triangular shape in cross section.

10. The device according to claim 1, wherein
at least one of the first electrode and the second electrode is provided along an outer wall of the dielectric.

11. The device according to claim 10, wherein
at least one of the first electrode and the second electrode is covered with a dielectric material.

12. The device according to claim 1, wherein at least one of the first electrode and the second electrode is provided along the inner wall of the dielectric, and at least one of the first electrode and the second electrode that are provided along the inner wall of the dielectric is covered with a dielectric material.

13. The device according to claim 1, further comprising:
a turbulence-generating member installed in the first region or an upstream region of the first region inside the flow path in a manner that a flow of a gas to be circulated inside the flow path is disturbed.
